(19) United States
(12) Patent Application Publication
(10) Pub. No.: US 2019/0265452 A1
(43) Pub. Date: Aug. 29, 2019

(54) MAGNIFYING DISPLAY DEVICE

(71) Applicant: E-LEAD ELECTRONIC CO., LTD., CHANGHUA (TW)

(72) Inventors: Stephen CHEN, CHANGHUA (TW); Kolya CHEN, CHANGHUA (TW)

(21) Appl. No.: 15/919,593

(22) Filed: Mar. 13, 2018

(30) Foreign Application Priority Data
Feb. 26, 2018 (TW) 107202611

(51) Int. Cl. G02B 17/06; G02B 7/182

(52) U.S. Cl. CPC G02B 17/0621; G02B 7/182

(57) ABSTRACT

A magnifying display device, which includes a fixed base, an arm, a flip stand, a reflective module and a magnifying module, objects could be magnified several times and imaged far longer than several times of the object distance according to the principle of virtual imaging of concave mirrors, the magnified images users looked is imaged in a visual distance farther than two meters, to relieve visual fatigue caused by overuse of eyes at close range, to thereby slow down myopia progression.

### BACKGROUND OF THE INVENTION

### a) Field of the Invention

The invention relates to a magnifying display device and, more particularly, to a magnifying display device easy to use, to relieve visual fatigue caused by overuse of eyes at close range, to thereby slow down myopia progression.

### b) Description of Prior Art

Medicine has proven that look near for a long time is the main cause of myopia except 5% genetic factors. Let's recall activities in daily life that looking near for a long time. Watching TV may usually be thought of, but distance between users and TV is above two or three meters, it is not really looking near. As for eating or dressing, although it is looking near, it is not for a long time. The main activities that looking near for a long time is reading books and writing, looking at mobile phones, tablets and computers may also be added in recent years. Text is the key of humans entering into civilized life, but it has also changed the habit of humans using eyes. Humans rarely look near before using text, so myopia should be a visual problem with a very low probability for ancient humans, and this also explains why humans with myopia have not been eliminated by evolutionism. After text has been invented, myopia spread in a small number of literate people. With the popularization of education, myopia has become common. In recent years, because almost everyone has a smart phone or a tablet, myopia has become normal gradually.

Ophthalmologists often recommend people to keep a distance of 30 cm while reading or writing, and a distance of 60 cm while using a computer, wherein 30 cm or 60 cm is not strict, but just health for eyes. Actually, it is just limited by the operating distance and the size of text and pictures on screen or on books that could not see clearly if it is too far, so the recommendation exists. If it is not limited by operating distance, for example, a computer is used with a mouse, the screen could be farther than books, texts and pictures could be enlarged. Whether a user reads a book or looks at a computer screen, the longer the visual distance the more eye health benefits.

Shortening time to look at near objects means reducing the amount of time spent on reading and writing, and it may let score regress. Do not let children play smart phone is deprived of their leisure, and there are unrealistic difficulties. The only choice that does not affect grades and leisure is to let the visual distance of reading and writing be longer. However, if the visual distance becomes longer, eye recognition ability may decrease, so it is easy to make eyes tired unless fonts and images are enlarged. Moreover, a longer visual distance may exceed the range of human hands, and the visual distance limit of reading and writing naturally is about 40 cm. To increase the visual distance may have to rely on new technology.

In order to solve the above existing problems, the industry has proposed various technical solutions continuously, related technologies can be referred to cited references CN 102692710B, CN 203057249U, CN 203608282U, CN 201060318Y, TW M550572, TW 1518369, TW 1563361, TW M541404, TW M535811, TW M536362, TW M548275, TW publication number 298625.

As shown in FIG. 1, it is a system 1 for remote reading system controlling juvenile myopia progression according to the cited reference CN102692710B, which comprises a housing 11, optical amplifying elements and collimation elements sequentially disposed in the housing 11, and a light source 3 next to the bracket. The amplifying optical elements include a lens 12, a first plane mirror 14, a dichroic mirror 15 for receiving light reflected from the first plane mirror 14 and a concave mirror 16, a second plane mirror 17 above the dichroic mirror 15 for receiving light reflected from the dichroic mirror 15, and a screen 18 for receiving light reflected from the second plane mirror 17. The screen 8 is perpendicular to the reflected light of the front surface of the second plane mirror 17. The collimation elements constitute the dichroic mirror 15 and the second plane mirror 17, a dichroic mirror midline knob 19 and a second plane mirror knob 110 are respectively set on the middle line of the dichroic mirror 15 and the second plane mirror 17. In the cited reference CN102692710B, users feel like texts and pictures are from five meters away when reading, so it may relieve visual fatigue caused by overuse of eyes at close range, to thereby slow down myopia progression. However, it is not convenient to set and tidy up because of many components, and users may feel it's awkward to handle.

### SUMMARY OF THE INVENTION

In view of this, the inventor finally accomplished the magnifying display device of the present invention after numerous improvements, namely, the object of the invention is to provide a magnifying display device easy to use, objects could be magnified several times and imaged far longer than several times of the object distance according to the principle of virtual imaging of concave mirrors, so that adverse effect of looking near could be significantly reduced, to relieve visual fatigue caused by overuse of eyes at close range, to thereby slow down myopia progression.

To achieve the object of the present invention, the magnifying display device of the present invention includes:

a fixed base, a first shaft group is set on its one side;

an arm, a first shaft group is set on its one end, a second shaft group is set on the other end;

a flip stand, which includes a third shaft group and a fourth shaft group, the third shaft group is set on one end of the flip stand, the fourth shaft group is set on the other end of the flip stand;

a reflective module, which includes a reflective sheet, the reflective sheet is provided to receive an image and reflect the image, the third shaft group is set on one side of the reflective module;

a magnifying module, which includes a magnifying sheet, the magnifying sheet is provided to receive an reflection image reflected by the reflective sheet and display a magnified image of the reflection image, the fourth shaft group is set on one side of the magnifying module, the magnifying module is pivoted to the second shaft group.

The above reflective sheet is a convex mirror.

The above magnifying sheet is a concave mirror.

The above third shaft group, which includes a first torsion spring, a third end seat set on one end of the flip stand and a third shaft seat set on one end of the reflective module, to provide for the flip stand and the reflective module to pivot together, the reflective module is flipped outwards by the resilience of the first torsion spring, a first limit groove set on the third shaft seat is embedded with a first limit column set on the third end seat, to thereby limit the flip angle of the reflective module.

The above fourth shaft group includes a second torsion spring, a fourth end seat set on the other end of the flip stand and a fourth shaft seat set on one end of the magnifying module, to provide the flip stand and the magnifying module to pivot together, the flip stand is flipped outwards by the resilience of the second torsion spring, a second limit groove set on the fourth shaft seat is embedded with a second limit column set on the fourth end seat, to thereby limit the flip angle of the flip stand.

The above first shaft group includes a first elastic piece, the first elastic piece provides elasticity for the arm to fix its angle.

The above second shaft group includes a second elastic piece, the second elastic piece provides elasticity for the magnifying module to fix its angle.

The above fixed base, multiple non-slip pads are set on its bottom.

The pivot position of the second shaft group and the magnifying module is set on the back side or lateral side of the magnifying module.

The above fixed base, wherein a fastener is set on it, the fastener is provided to fix the reflective module.

The above magnifying module, a buckle portion is set on its one side, a Velcro is set on a position of the fixed base corresponded to the buckle portion, the Velcro is used to attach to the buckle portion to provide for the magnifying display device to be fastened.

According to the magnifying display device of the present invention, objects could be magnified several times and imaged far longer than several times of the object distance according to the principle of virtual imaging of concave mirrors, the magnified images users looked is imaged in a visual distance farther than two meters, so that adverse effect of looking near could be significantly reduced, to relieve visual fatigue caused by overuse of eyes at close range, to thereby slow down myopia progression.

### BRIEF DESCRIPTION OF THE DRAWINGS

FIG. 1 is a schematic diagram of configuration of the cited reference;

FIG. 2 is a three-dimensional exploded diagram of the present invention;

FIG. 3 is a three-dimensional schematic diagram of the present invention being unfolded;

FIG. 4 is a schematic diagram of embodiment of the present is invention;

FIG. 5 is a schematic diagram of the unfolding motion of the present invention;

FIG. 6 is a schematic diagram of the present invention being folded;

FIG. 7 is a schematic diagram of the first embodiment of the present invention being folded;

FIG. 8 is a schematic diagram of the second embodiment of the present invention being folded;

FIG. 9 is a schematic diagram of limit structure of the present invention being unfolded;

FIG. 10 is a schematic diagram of limit structure of the present invention being folded; and

FIG. 11 is a schematic diagram of the embodiment of the fourth shaft pivoted to the back side of the magnifying module of the present invention.

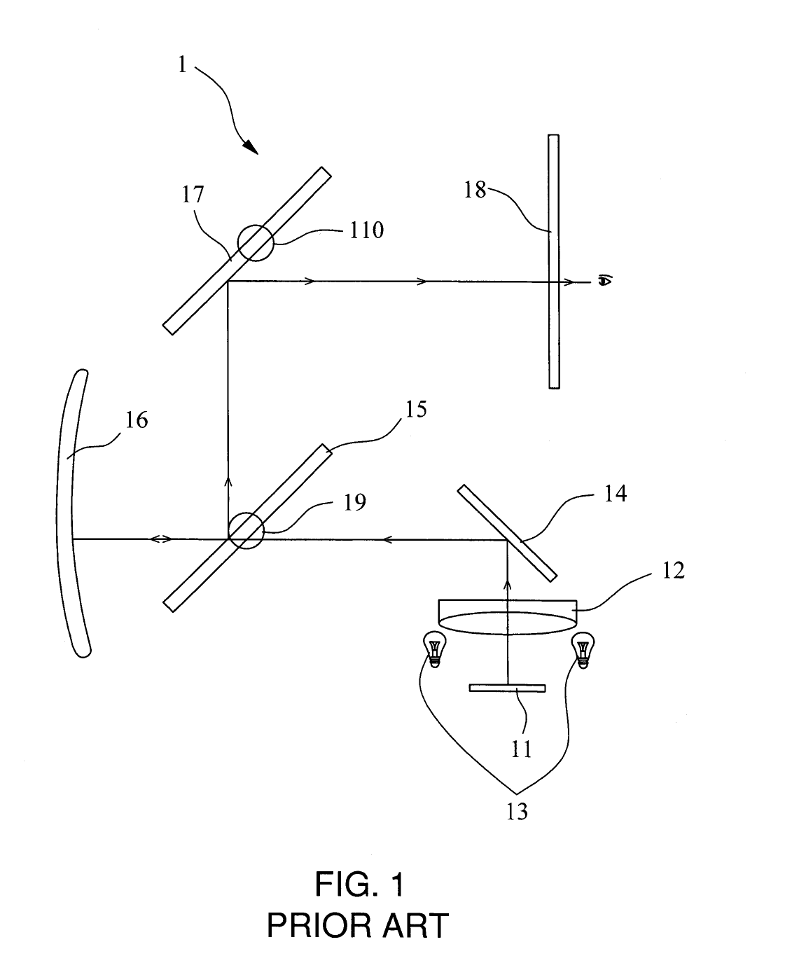

### DETAILED DESCRIPTION OF THE INVENTION

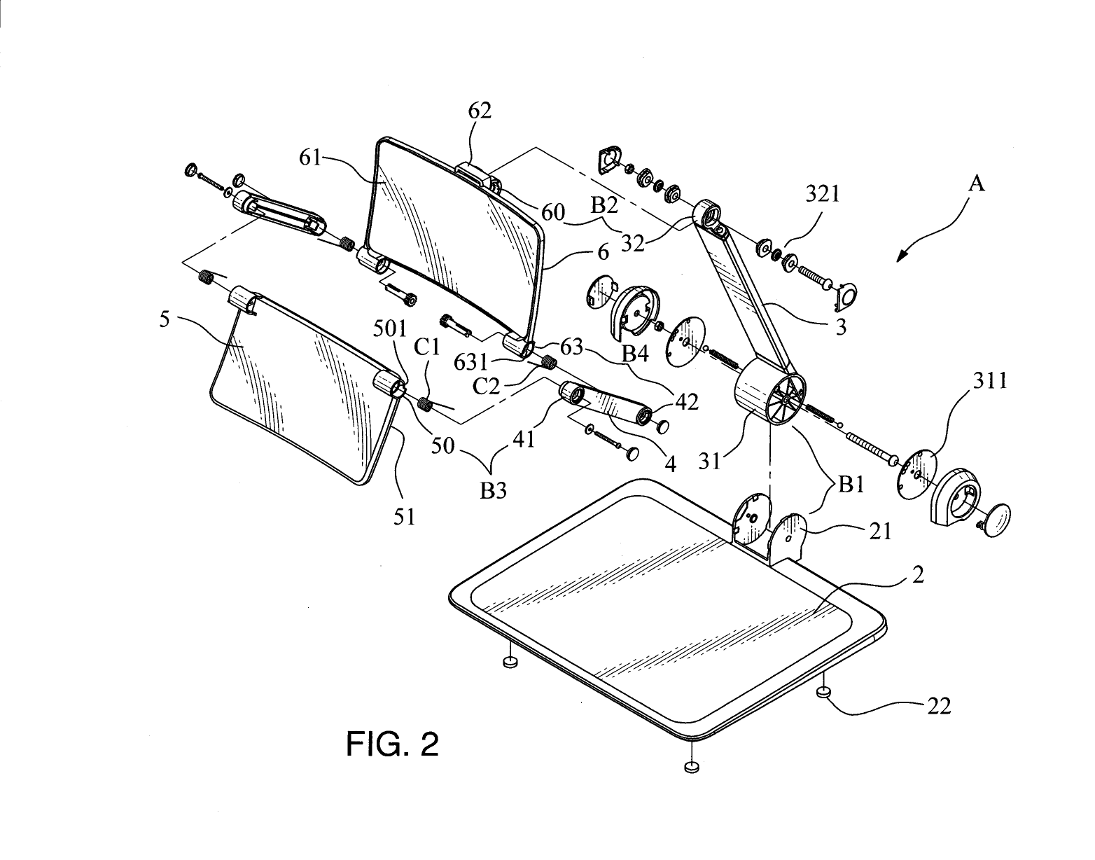

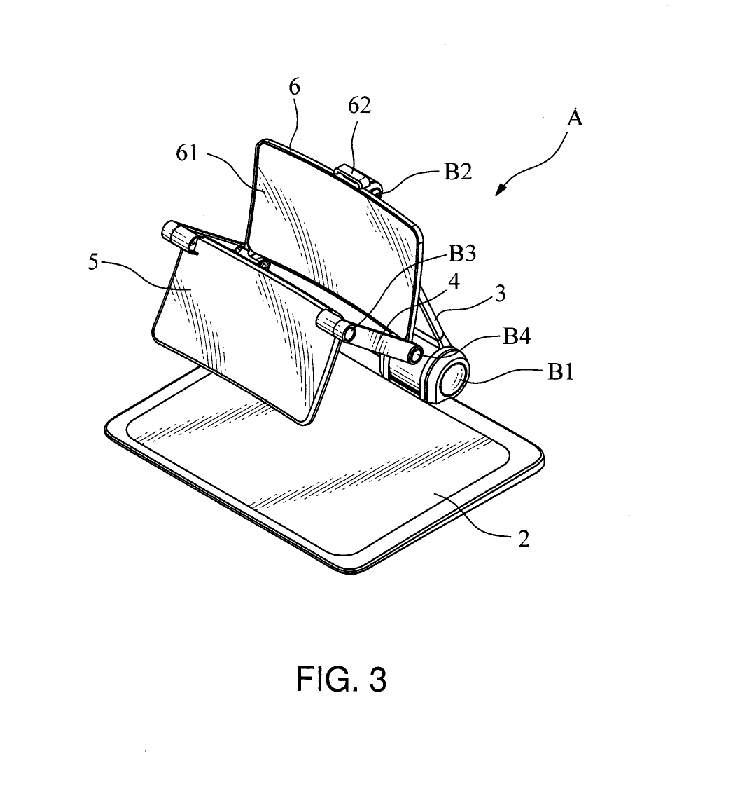

Please refer to FIG. 2, FIG. 3, the magnifying display device A of the present invention includes:

a fixed base 2, a first shaft group B1 is set on its one side, the fixed base 2 is provided for a book to put on it;

an arm 3, the first shaft group B1 is set on its one end, the first shaft group B1 includes a first elastic piece 311, the first elastic piece 311 provides elasticity for the first shaft group B1 to fix its angle, a second shaft group B2 is set on the other end of the arm 3, the second shaft group B2 includes a second elastic piece 321, the second elastic piece 321 provides elasticity for the second shaft group B2 to fix its angle;

a flip stand 4, which includes a third shaft group B3 and a fourth shaft group B4, the third shaft group B3 is set on one end of the flip stand 4, the fourth shaft group B4 is set on the other end of the flip stand 4;

a reflective module 5, which includes a reflective sheet 51, the reflective sheet 51 is a convex mirror, the reflective sheet 51 is provided to receive an image and reflect it, the third shaft group B3 is pivoted on one side of the reflective module 5, the third shaft group B3 includes a first torsion spring C1, the first torsion spring C1 provides elasticity for the reflective module 5 to be flipped, so that the reflective module 5 could be flipped;

a magnifying module 6, which includes a magnifying sheet 61, the magnifying sheet 61 is a concave mirror, the magnifying sheet 61 is provided to receive an reflection image reflected by the reflective sheet 51 and display a magnified image of the reflection image. Principle of virtual imaging is imaging by using a concave mirror, the imaging formula of a concave mirror is: 1/p+1/q=1/f, wherein f: focal distance, q: object distance, p: image distance. By using a general magnification, virtual images could be enlarged and virtual image distance could also be farther at the same ratio. The magnifying sheet 61 receives the reflection image reflected by the reflective sheet 51 and displays the magnifying reflection image. The fourth shaft group B4 is pivoted on one side of the magnifying module 6, the magnifying module 6 is pivoted to the second shaft group B2, the pivot position of the fourth shaft group B4 and the magnifying module 6 could be set on the back side or lateral side of the magnifying module 6, the fourth shaft group B4 includes a second torsion spring C2, the second torsion spring C2 provides elasticity for the flip stand 4 to be is flipped.

The above first shaft group B1 is consisted of a pair of first shaft seats 21 of the fixed base 2 and a first end seat 31 set on one end of the arm 3 to thereby be provided for the arm 3 and the fixed base 2 to pivot together. The first elastic piece 311 is set in the first shaft group B1, the first elastic piece 311 provides elasticity for the arm 3 to fix its angle.

The above second shaft group B2 is consisted of a second shaft seat 60 of the magnifying module 6 and a second end seat 32 set on the other end of the arm 3, to thereby be provided for the arm 3 and the magnifying module 6 to pivot together. The second elastic piece 321 is set in the second shaft group B2, the second elastic piece 321 provides elasticity for the magnifying module 5 to fix its angle.

The above third shaft group B3 is consisted of a third end seat 41 set on one end of the flip stand 4 and a third shaft seat 50 set on one end of the reflective module 5, to provide for the flip stand 4 and the reflective module 5 to pivot together.

The above fourth shaft group B4 is consisted of a fourth end seat 42 set on the other end of the flip stand 4 and a fourth shaft seat 63 set on one end of the magnifying module 6, to provide for the flip stand 4 and the magnifying module 6 to pivot together.

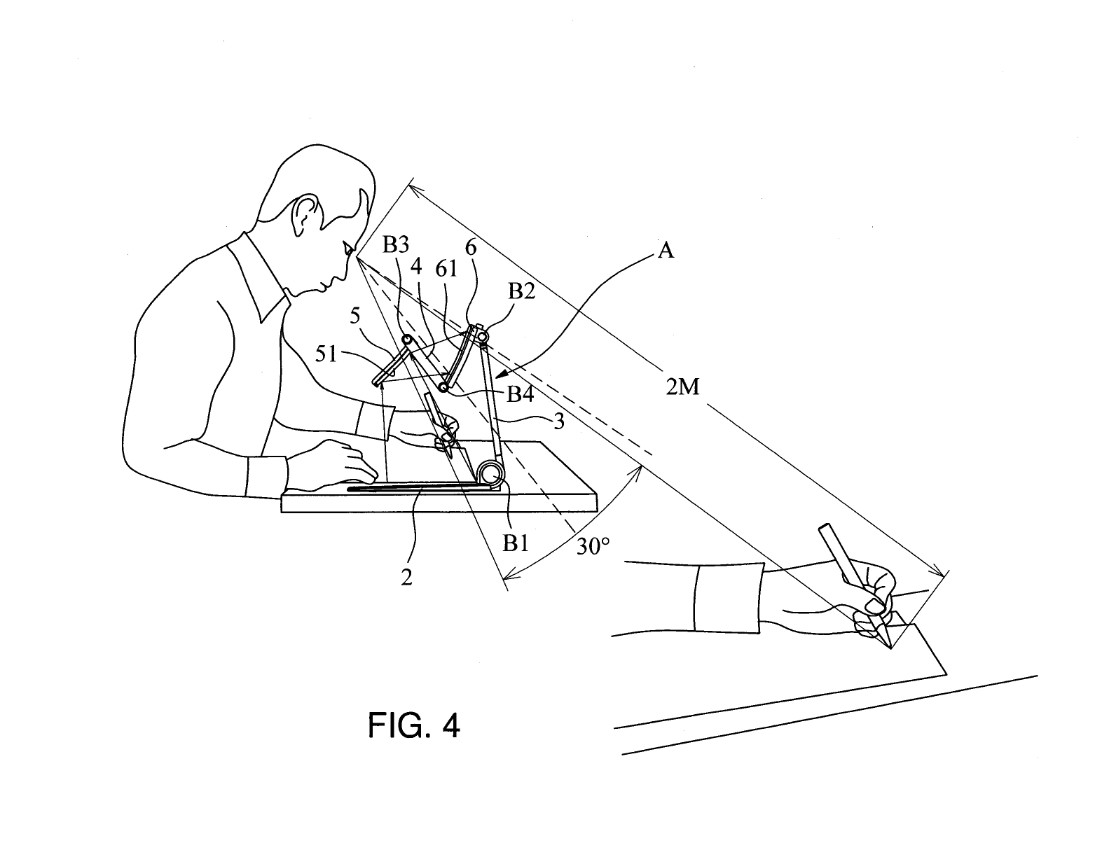

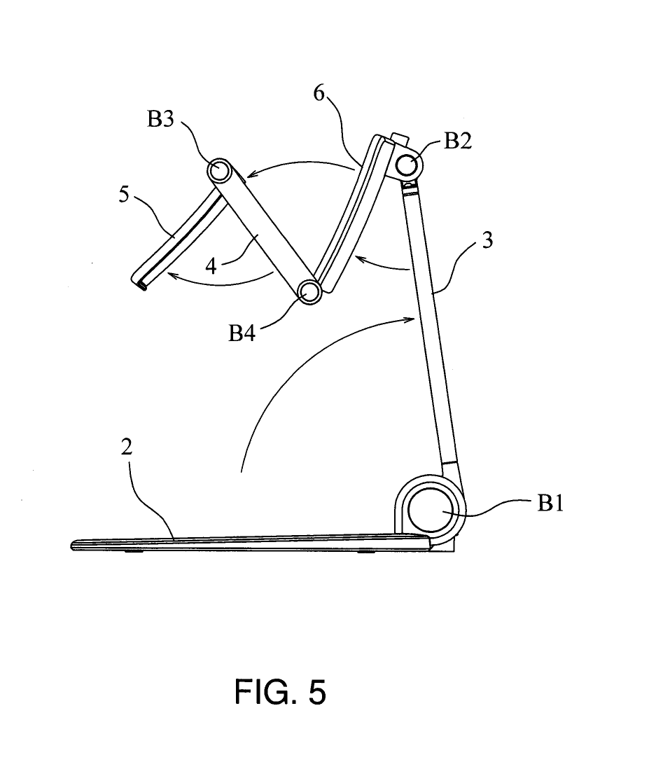

As shown in FIG. 4 and FIG. 5, which are respectively schematic diagrams of unfolding embodiment and motion of the present invention being used, when the magnifying display device A is unfolded, the reflective module 5 and the flip stand 4 are automatically expanded to the watch location by the elasticity of the first torsion spring C1 and the second torsion spring C2 respectively. Further, the angle and the location of the arm 3 and the magnifying module 6 could be adjusted slightly by hands, so that users could look the magnified image in air. For example, when a user is reading a book, the reflective sheet 51 receives the image of the book and reflects the image, the magnifying sheet 61 receives the image reflected by the reflective sheet 51 and magnified the reflected image, so the user could look the far magnified image.

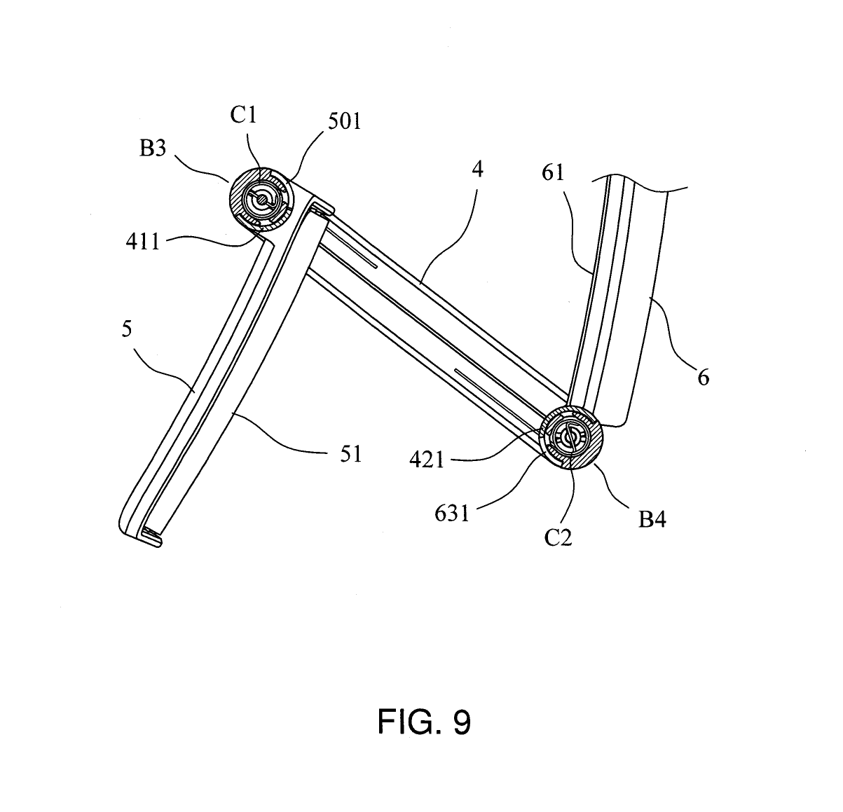

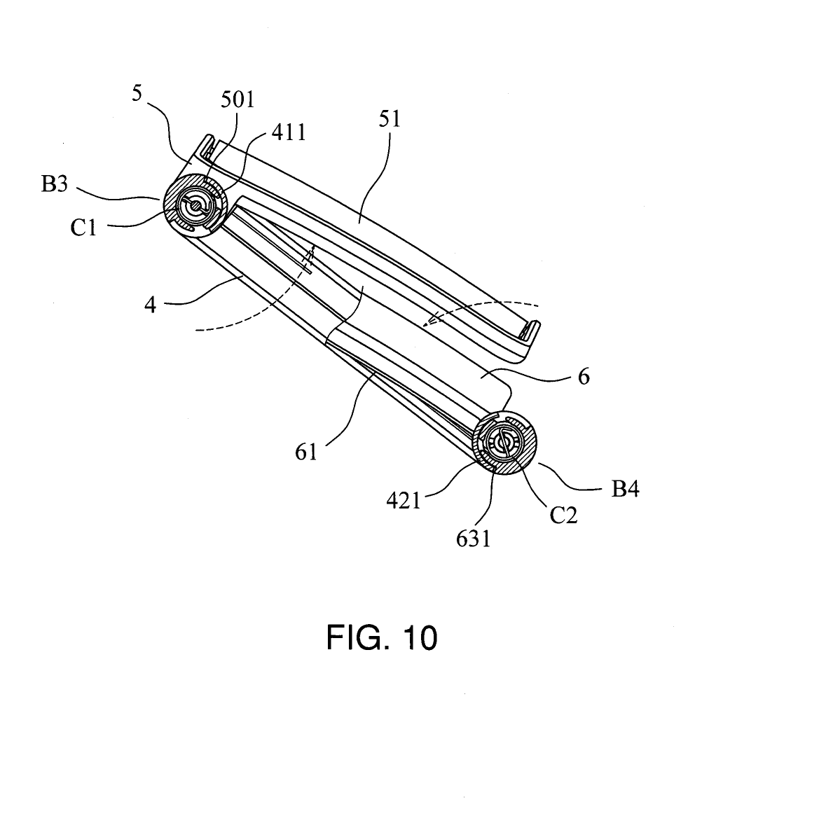

The above first torsion spring C1 and the second torsion spring C2 are compressed when the present invention is folded. Therefore, when the present invention is opened, the flip stand 4 and the reflective module 5 are flipped outwards by the resilience of the first torsion spring C1 and the second torsion spring C2. In the flip process, a predetermined position is flipped to (for example, a 45 degree angle is flipped to), a first limit groove 501 set on the third seat 50 is embedded with a first limit column 411 set on the third end seat 41, to thereby limit the flip angle and folding of the reflective module 5; a second limit groove 631 set on the fourth shaft seat 63 is embedded with a limit column se on the fourth end seat 42, to thereby limit the flip angle and folding of the flip stand 4 (as shown in FIG. 9 and FIG. 10).

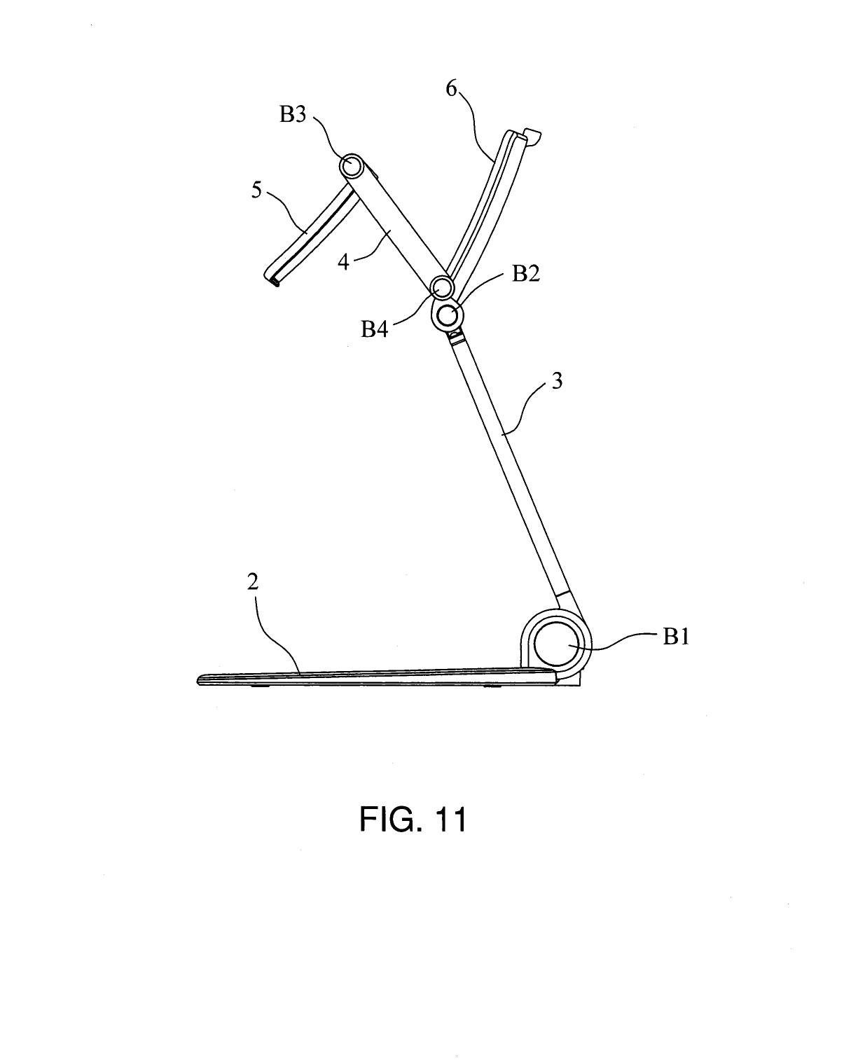

In the present invention, the pivot position of the second shaft group B2 and the magnifying module 6 could be ideally set on the top of the back side of the magnifying module 6 or any portion or bottom of the back side of the magnifying module 6, or set on the lateral side of the magnifying module 6 (as shown in FIG. 11).

The implementation of the present invention is according to the principle of virtual imaging of concave mirrors in physical optics that objects could be magnified several times and imaged far longer than is several times of the object distance. The optical technology could solve the problem that school children look near objects for a long time. Putting a book, writing or using a mobile phone under this optical device, what the user looks is a magnified image in a visual distance farther than two meters, so that adverse effect of school children looking near could be significantly reduced.

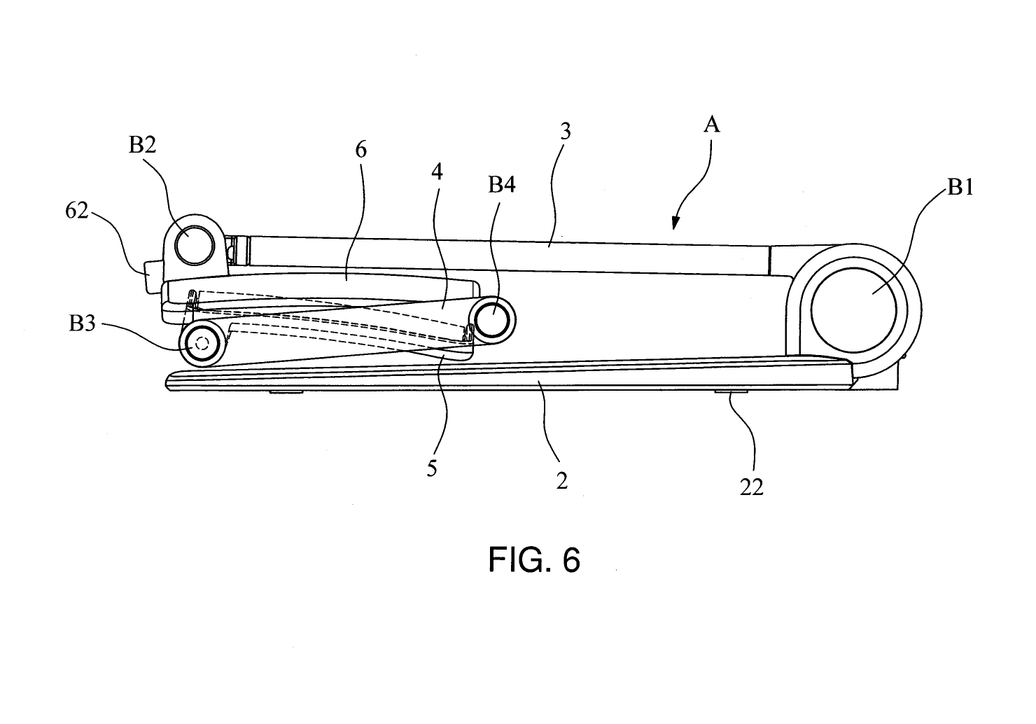

As shown in FIG. 2 and FIG. 6, wherein multiple non-slip pads 22 are set on the bottom of the fixed base 2 to prevent the magnifying display device A from moving.

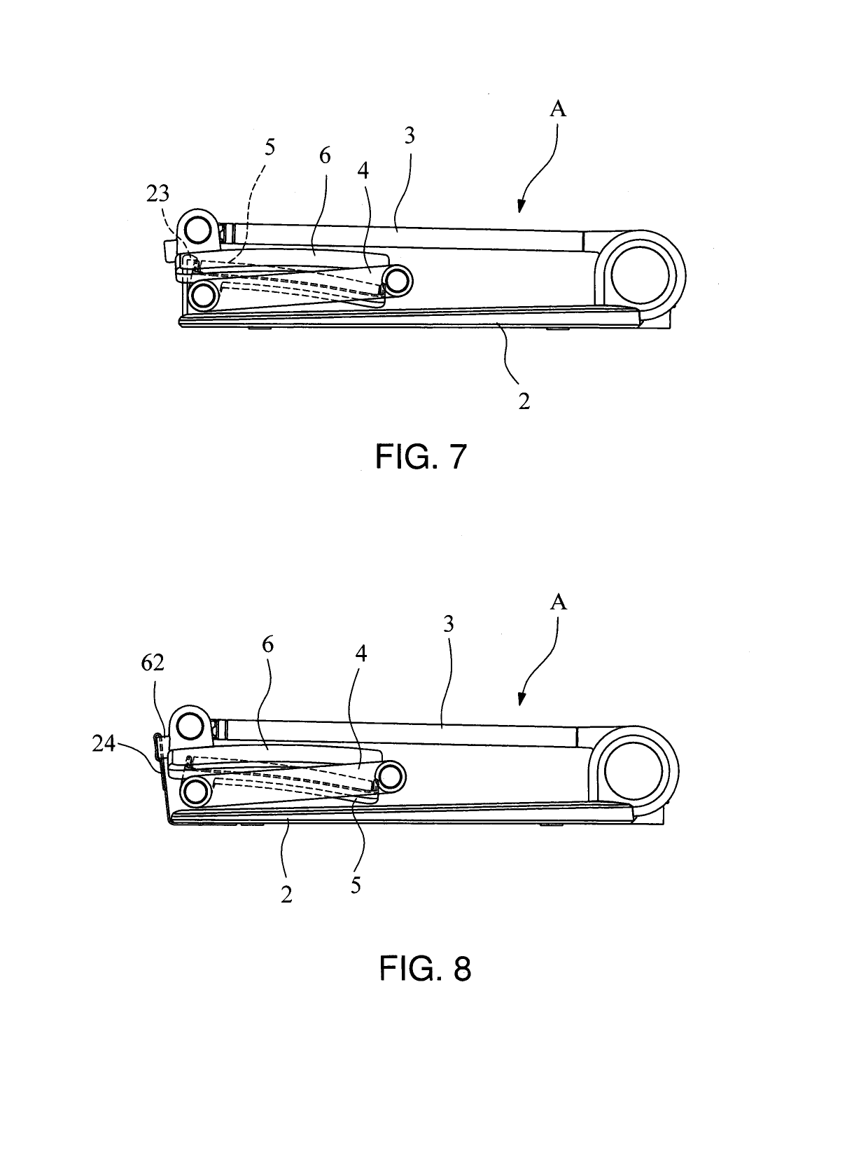

As shown in FIG. 7, it is a schematic diagram of the first embodiment of the present invention being folded, wherein a fastener 23 is set on the fixed base 2, the fastener 23 is provided to fix to one side of the reflective module 5 when the present invention is in the folding position, to thereby provide for the magnifying display device A to be folded and fixed.

As shown in FIG. 2 and FIG. 8, it is a schematic diagram of the second embodiment of the present invention being folded, wherein a buckle portion 62 is set on one side of the magnifying module 6. A Velcro is set on a position of the fixed base 2 corresponded to the buckle portion 62, when the present invention is in folding position, the attachment of the Velcro 24 and the buckle portion 62 is provided for the magnifying display device A to be fastened.

What is claimed is:

1. A magnifying display device, including:
a fixed base, a first shaft group is set on its one side;
an arm, a first shaft group is set on its one end, a second shaft group is set on the other end;
a flip stand, which includes a third shaft group and a fourth shaft group, the third shaft group is set on one end of the flip stand, the fourth shaft group is set on the other end of the flip stand;
a reflective module, which includes a reflective sheet, the reflective sheet is provided to receive an image and reflect the image, the third shaft group is pivoted on one side of the reflective module;
a magnifying module, which includes a magnifying sheet, the magnifying sheet is provided to receive an reflection image reflected by the reflective sheet and display a magnified image of the reflection image, the fourth shaft group is pivoted to one side of the magnifying module, the magnifying module is pivoted to the second shaft group.

2. The magnifying display device as claimed in claim 1, wherein the reflective sheet is a convex mirror, the magnifying sheet is a concave mirror.

3. The magnifying display device as claimed in claim 1, wherein the third shaft group includes a first torsion spring, a third end seat set on one end of the flip stand and a third shaft seat set on one end of the reflective module, to provide the flip stand and the reflective module to pivot together, the reflective module is flipped outwards by resilience of the first torsion spring, a first limit groove set on the third shaft seat is embedded with a first limit column set on the third end seat, to thereby limit the flip angle of the reflective module.

4. The magnifying display device as claimed in claim 1, wherein the fourth shaft group includes a second torsion, a fourth end seat set on the other end of the flip stand and a fourth shaft seat set on one end of the magnifying module, to provide the flip stand and the magnifying module to pivot together, the flip stand is flipped outwards by resilience of the second torsion spring, a second limit groove set on the fourth shaft seat is embedded with a second limit column set on the fourth end seat, to thereby limit the flip angle of the flip stand.

5. The magnifying display device as claimed in claim 1, wherein the first shaft group includes a first elastic piece, the first elastic piece provides elasticity for the arm to fix its angle, the second shaft group includes a second elastic piece, the second elastic piece provides elasticity for the magnifying module to fix its angle.

6. The magnifying display device as claimed in claim 1, wherein the pivot position of the second shaft group and the magnifying module is set on the back side of the magnifying module.

7. The magnifying display device as claimed in claim 1, wherein the pivot position of the second shaft group and the magnifying module is set on the lateral side of the magnifying module.

8. The magnifying display device as claimed in claim 1, wherein multiple non-slip pads are set on the bottom of the fixed base.

9. The magnifying display device as claimed in claim 1, wherein a fastener is set on the fixed base, the fastener is provided to fix the reflective module.

10. The magnifying display device as claimed in claim 1, wherein a buckle portion is set on one side of the magnifying module, a Velcro is set on a position of the fixed base corresponded to the buckle portion, the Velcro is used to attach to the buckle portion to provide for the magnifying display device to be fastened.
